(19) United States
(12) Patent Application Publication
(10) Pub. No.: US 2020/0088599 A1
(43) Pub. Date: Mar. 19, 2020

(54) HIGH TEMPERATURE CAPACITIVE PRESSURE SENSOR FABRICATED WITH VIA-FILLED SAPPHIRE WAFERS

(71) Applicant: Rosemount Aerospace Inc., Burnsville, MN (US)

(72) Inventor: Weibin Zhang, Burnsville, MN (US)

(21) Appl. No.: 16/133,944

(22) Filed: Sep. 18, 2018

(51) Int. Cl. G01L 19/00; G01L 19/04; G01L 9/00

(52) U.S. Cl. CPC G01L 19/0092; G01L 9/0075; G01L 19/04

(57) ABSTRACT

A high temperature capacitive pressure sensor includes a first sapphire wafer having a first exterior wafer surface and a first interior wafer surface, a recess extending into the first sapphire wafer, a second sapphire wafer having a second exterior wafer surface and a second interior wafer surface, a first hole extending through the first sapphire wafer, a second hole extending through the first sapphire wafer or the second sapphire wafer, a first via that solidly fills the first hole, the first via including a first interior via surface aligned with the first interior wafer surface, a second via that solidly fills the second hole, the second via including a second interior via surface aligned with the interior wafer surface of the sapphire wafer within which the second via extends, a first electrode deposited on the first interior wafer surface covering and contacting the first interior via surface.

### BACKGROUND

The present disclosure relates generally to pressure measurement devices, and in particular, to capacitive pressure sensors.

Capacitive pressure sensors are used to measure pressure by detecting a capacitance change between two electrodes of the sensor. Each electrode is positioned on a wafer. The wafers are hermetically sealed to form a capacitor chamber. Because of the hermeticity, pressure changes cause one or more of the wafers to move, altering the gap between the two electrodes and resulting in the capacitance change. Maintaining the sensor material stability as well as the hermeticity of the capacitive pressure sensor can be difficult for high temperature applications.

### SUMMARY

A high temperature capacitive pressure sensor includes a first sapphire wafer having a first exterior wafer surface and a first interior wafer surface, a recess extending into the first sapphire wafer at the first interior wafer surface, a second sapphire wafer having a second exterior wafer surface and a second interior wafer surface, a first hole defined by and extending through the first sapphire wafer, a second hole defined by and extending through the first sapphire wafer or the second sapphire wafer, a first electrically conductive via that solidly fills the first hole, the first via including a first interior via surface aligned with the first interior wafer surface, a second electrically conductive via that solidly fills the second hole, the second via including a second interior via surface aligned with the interior wafer surface of the sapphire wafer within which the second via extends, a first electrode deposited on the first interior wafer surface within the first recess and covering and contacting the first interior via surface, and a second electrode deposited on the second interior wafer surface and electrically connected to the second via. The second sapphire wafer is bonded to the first sapphire wafer at the first interior wafer surface and the second interior wafer surface to form a capacitor chamber.

A method of making a capacitive pressure sensor includes drilling a first hole in a first sapphire wafer, solidly filling the first hole with an electrically conductive first filler of a first via, polishing the first sapphire wafer and the first via such that a first interior via surface is aligned with a first interior wafer surface, depositing a first electrode on the first interior via surface and the first interior wafer surface, and bonding the first sapphire wafer to a second sapphire wafer to form a capacitor chamber, the first electrode being within the capacitor chamber.

### BRIEF DESCRIPTION OF THE DRAWINGS

FIG. 1 is a cross-sectional view of a capacitive pressure sensor.

FIG. 2 is a cross-sectional view of a capacitive pressure sensor having a first sapphire wafer with a first recess and a second sapphire wafer with a second recess.

FIG. 3 is a cross-sectional view of a capacitive pressure sensor having a first sapphire wafer with a first via and a second via and a connector connecting the second via and a second electrode.

FIG. 4 is a cross-sectional view of a capacitive pressure sensor having a first sapphire wafer with a first via, a second via, a first recess, and a connector connecting the second via and a second electrode of a second sapphire wafer having a second recess.

### DETAILED DESCRIPTION

In general, the present disclosure describes a capacitive pressure sensor that has sapphire wafers with vias that solidly fill holes in the sapphire wafers such that the interior and exterior surfaces of the vias are flush with the interior and exterior surfaces of the sapphire wafers. Electrodes are deposited onto the interior surfaces of the wafers and the interior surfaces of the vias before the wafers are bonded together to form a capacitor chamber. As a result, the capacitive pressure sensor is hermetically sealed and can withstand extreme high temperature environments, or environments at or above 800 degrees Celsius. Additionally, the process for forming the capacitive pressure sensor is more controlled and there is no risk of conductive paste reflowing or outgassing of the vias.

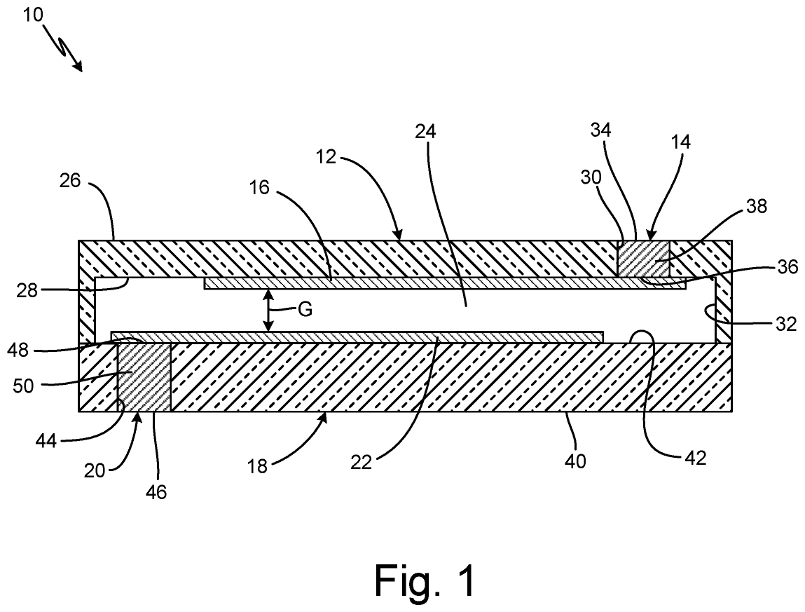

FIG. 1 is a cross-sectional view of capacitive pressure sensor 10. Capacitive pressure sensor 10 includes first sapphire wafer 12, first via 14, first electrode 16, second sapphire wafer 18, second via 20, second electrode 22, and capacitor chamber 24. First sapphire wafer 12 includes first exterior wafer surface 26, first interior wafer surface 28, first hole 30, and recess 32. First via 14 includes first exterior via surface 34, first interior via surface 36, and first filler 38. Second sapphire wafer 18 includes second exterior wafer surface 40, second interior wafer surface 42, and second hole 44. Second via 20 includes second exterior via surface 46, second interior via surface 48, and second filler 50.

Capacitive pressure sensor 10 is a high temperature capacitive pressure sensor. First sapphire wafer 12 is a dielectric single crystal sapphire membrane of capacitive pressure sensor 10. In this embodiment, first sapphire wafer 12 is a movable wafer. First via 14 extends through first sapphire wafer 12 and is hermetically sealed to first sapphire wafer 12. First via 14 is electrically conductive. First electrode 16 is positioned on first sapphire wafer 12 and first via 14. First electrode 16 is also electrically connected to first via 14. Second sapphire wafer 18 is a dielectric single crystal sapphire membrane of capacitive pressure sensor 10. In this embodiment, second sapphire wafer 18 is a stationary wafer. In alternate embodiments, second sapphire wafer 18 is a movable wafer. In further alternate embodiments, first sapphire wafer 12 is a stationary wafer and second sapphire wafer 18A is a movable wafer. Second via 20 extends through second sapphire wafer 18 and is hermetically sealed to second sapphire wafer 18. Second via 20 is electrically conductive. Second electrode 22 is positioned on second sapphire wafer 18 and second via 20. Second electrode 22 is also electrically connected to second via 20. First sapphire wafer 12 is peripherally and hermetically bonded to second sapphire wafer 18 to form capacitor chamber 24, first electrode 16 and second electrode 22 being within capacitor chamber 24. Capacitor chamber 24 is hermetically sealed. First electrode 16 is opposite second electrode 22 within capacitor chamber 24, such that gap G is formed between first electrode 16 and second electrode 22.

First exterior wafer surface 26 is at a first side of first sapphire wafer 12, and first interior wafer surface 28 is at a second side of first sapphire wafer 12. First interior wafer surface 28 partially defines capacitor chamber 24. First hole 30 is an opening defined by first sapphire wafer 12 that extends through first sapphire wafer 12 from first exterior wafer surface 26 to first interior wafer surface 28. Recess 32 extends into first sapphire wafer 12 at first interior wafer surface 28. Recess 32 has a substantially uniform depth. First electrode 16 is positioned on first interior wafer surface 28 within recess 32.

First exterior via surface 34 is at a first side of first via 14, and first interior via surface 36 is at a second side of first via 14. First via 14 is within first hole 30 such that first via 14 solidly fills first hole 30, or takes up the entire space of first hole 30 such that first hole 30 is completely filled and no air gaps exist between first via 14 and first hole 30. First exterior via surface 34 is about flush, or essentially co-planar, with first exterior wafer surface 26, and first interior via surface 36 is about flush, or essentially co-planar, with first interior wafer surface 28. First electrode 16 is positioned on first interior wafer surface 28 and first interior via surface 36. First interior via surface 36 may be slightly dimpled, but remains aligned with first interior wafer surface 28 so that first electrode 16 contacts and covers first interior via surface 36. In this embodiment, first electrode 16 fully covers first interior via surface 36. First via 14 comprises, or is formed of, electrically conductive first filler 38. In this embodiment, first filler 38 is a gold-based paste or material that becomes solid gold during formation of first via 14. As such, first filler 38 begins as a paste primarily made of gold and solidifies to become solid gold, which has a high melting point. In alternate embodiments, first filler 38 may be a platinum-based material or any other suitable metal-based material that solidifies to become a solid metal with a high melting point such that first filler 38 can withstand extreme high temperature applications.

Second exterior wafer surface 40 is at a first side of second sapphire wafer 18, and second interior wafer surface 42 is at a second side of second sapphire wafer 18. Second interior wafer surface 42 partially defines capacitor chamber 24. Second hole 44 is an opening defined by second sapphire wafer 18 that extends through second sapphire wafer 18 from second exterior wafer surface 40 to second interior wafer surface 42. Second electrode 22 is positioned on second interior wafer surface 42.

Second exterior via surface 46 is at a first side of second via 20, and second interior via surface 48 is at a second side of second via 20. Second via 20 is within second hole 44 such that second via 20 solidly fills second hole 44, or takes up the entire space of second hole 44 such that second hole 44 is completely filled and no air gaps exist between second via 20 and second hole 44. Second exterior via surface 46 is about flush, or essentially co-planar, with second exterior wafer surface 40, and second interior via surface 48 is about flush, or essentially co-planar, with second interior wafer surface 42. Second electrode 22 is positioned on second interior wafer surface 42 and second interior via surface 48. Second interior via surface 48 may be slightly dimpled, but remains aligned with second interior wafer surface 42 so that second electrode 22 contacts and covers second interior via surface 48. In this embodiment, second electrode 22 fully covers second interior via surface 48. Second via 20 comprises, or is formed of, electrically conductive second filler 50. In this embodiment, second filler 50 is a gold-based paste or material that becomes solid gold during formation of second via 20. As such, second filler 50 begins as a paste primarily made of gold and solidifies to become solid gold, which has a high melting point. In alternate embodiments, second filler 50 may be a platinum-based material or any other suitable metal-based material that solidifies to become a solid metal with a high melting point such that second filler 50 can withstand extreme high temperature applications.

Capacitive pressure sensor 10 is made by drilling, such as by laser drilling, first hole 30 in first sapphire wafer 12 and drilling, such as by laser drilling, second hole 44 in second sapphire wafer 18. First hole 30 is solidly, or completely, filled with first via 14, and second hole 44 is solidly, or completely, filled with second via 20. To fill first hole 30, first filler 38 of first via 14 is pressed into first hole 30 in the form of a paste. First filler 38 is then heated until first filler 38 bonds and solidifies to become hermetically sealed to first sapphire wafer 12. To fill second hole 44, second filler 50 of second via 20 is pressed into second hole 44 in the form of a paste. Second filler 50 is then heated until second filler 50 bonds and solidifies to become hermetically sealed to second sapphire wafer 18. Because first via 14 and second via 20 comprise first filler 38 and second filler 50, respectively, which have high melting points, such a bonding process occurs at a temperature high enough to melt first filler 38 and second filler 50.

The first sapphire wafer 12 and the second sapphire wafer 18 are then EPI-polished to grind down, or remove, excess first filler 30 and second filler 50, respectively, until first exterior via surface 34, first interior via surface 36, second exterior via surface 46, and second interior via surface 48 are essentially flat, and first sapphire wafer 12 and second sapphire wafer 18 are restored for further bonding. Specifically, first sapphire wafer 12 and first via 14 are polished such that first exterior via surface 34 is about flush, or essentially co-planar, with first exterior wafer surface 26 and first interior via surface 36 is about flush, or essentially co-planar, with first interior wafer surface 28. Second sapphire wafer 18 and second via 20 are polished such that second exterior via surface 46 is about flush, or essentially co-planar, with second exterior wafer surface 40 and second interior via surface 48 is about flush, or essentially co-planar, with second interior wafer surface 48. Following the formation of first via 14 and second via 20, first interior wafer surface 28 of first sapphire wafer 12 is then etched to form recess 32. In alternate embodiments, recess 32 may be etched before the formation of first via 14 and second via 20.

First electrode 16 is deposited on an essentially flat surface formed by first interior wafer surface 28 and first interior via surface 36 such that first electrode 16 is positioned on both first interior wafer surface 28 and first interior via surface 36. Second electrode 22 is deposited on an essentially flat surface formed by second interior wafer surface 42 and second interior via surface 48 such that second electrode 22 is positioned on both second interior wafer surface 42 and second interior via surface 48.

First sapphire wafer 12 is directly peripherally bonded to second sapphire wafer 18 at first interior wafer surface 28 and second interior wafer surface 42, respectively, through sapphire-sapphire direct bonding under vacuum to hermetically seal first sapphire wafer 12 to second sapphire wafer 18 and to form capacitor chamber 24. More specifically, first sapphire wafer 12 is bonded to second sapphire wafer 18 in a vacuum oven, and first recess 32 partially defines capacitor chamber 24. As a result, sealed capacitor chamber 24 is a vacuum chamber, which is required for pressure sensing.

First sapphire wafer 12 and second sapphire wafer 18 withstand extreme high temperatures because they are made of sapphire. Additionally, first filler 38 and second filler 50 that make up first via 14 and second via 20, respectively, can withstand extreme high temperatures because they are made of materials with high melting points. As such, capacitive pressure sensor 10 has the ability to measure pressure in extreme high temperature environments.

Capacitive pressure sensor 10 measures pressure by detecting a capacitance change between first electrode 16 and second electrode 18. Capacitance is a function of gap G between first electrode 16 and second electrode 18. Gap G changes when movable first sapphire wafer 12 deflects toward or away from stationary second sapphire wafer 18 as a result of external pressure due to the vacuum within capacitor chamber 24. First via 14 and second via 20 are physically and electrically connected to first electrode 16 and second electrode 22, respectively, to communicate the capacitance change as first sapphire wafer 12 and second sapphire wafer 18 are non-conductive.

First via 14 and second via 20 solidly fill first hole 30 and second hole 44, respectively, to achieve hermetic sealing. Polishing down excess first filler 30 and second filler 50 creates flat surfaces that allow first electrode 16 and second electrode 22 to fully cover first interior via surface 36 and second interior via surface 48, respectively, so that no leaks can occur at edges of first via 14 and second via 20. Specifically, first electrode 16 and second electrode 20 can fully cover first interior via surface 36 and second interior via surface 48, respectively, because first interior via surface 36 is about flush with first interior wafer surface 28 and second interior via surface 48 is about flush with second interior wafer surface 42. As a result, first electrode 16 and second electrode 20 provide another layer of sealing by covering first hole 30 and second hole 44, further ensuring that capacitor chamber 24 is hermetically sealed.

Traditionally, capacitive pressure sensors may include vias formed by metal film sputtering or conductive paste printing after the first wafer and the second wafer have already been bonded together to form the capacitor chamber. Vias comprising metal thin films can be difficult to hermetically seal because the holes in which the vias are positioned often have rough and uneven sidewalls and edges. Vias comprising conductive paste, such as glass frit, can be challenging to form because enough conductive paste needs to be pressed into the hole to contact the electrode and provide hermetic sealing, but not so much paste can be pressed in that the paste begins flowing into the capacitor chamber. Further, traditional conductive pastes can outgas during the curing process, disrupting the hermeticity of the capacitor chamber. Additionally, traditional conductive pastes are unsuitable for high temperature environments because they melt and reflow, which also disrupts the hermetic seal. As a result, typical capacitive pressure sensors can be difficult to form and difficult to hermetically seal, particularly in high temperature environments.

Capacitive pressure sensor 10 is suitable for use in extreme high temperature applications, such as 800 degrees Celsius or above, and other harsh environmental applications. Because first via 14 and second via 20 are made of gold-based material that has a melting point higher than traditional fillers, first via 14 and second via 20 are not at risk of outgassing or reflowing and still provide good electric conduction. Capacitive pressure sensor 10 is easy to hermetically seal because first hole 30 and second hole 44 are solidly filled with first via 14 and second via 20. Capacitive pressure sensor 10 remains hermetically sealed not only because first via 14 and second via 18 do not outgas or reflow, but also because first electrode 16 and second electrode 22 provide additional seals over first hole 30 and second hole 44, respectively. Maintaining hermeticity is important because capacitive pressure sensor 10 must be hermetically sealed in order to maintain a vacuum within capacitor chamber 24, which is necessary in order for capacitive chamber 24 to function properly. For example, if capacitive pressure sensor 10 is not hermetically sealed and capacitive chamber 24 is no longer a vacuum chamber, first sapphire wafer 12 does not properly deflect in response to external pressure.

More control over the formation of capacitive pressure sensor 10 is also possible because first via 14 and second via 20 are formed before first sapphire wafer 12 is bonded to second sapphire wafer 18. First, since first via 14 and second via 20 are formed before capacitor chamber 24 is formed, high temperature first filler 30 and second filler 50 can be used without considering high temperature heating effects on other processes or components of capacitive pressure sensor 10. Second, because first sapphire wafer 12 is still separate from second sapphire wafer 18, first interior wafer surface 28, first interior via surface 36, second interior wafer surface 42, and second interior via surface 48 are easily visible and accessible. As a result, first interior via surface 36 and second interior via surface 48 can be polished, and first electrode 16 and second electrode 22 can be deposited on first interior via surface 36 and second interior via surface 48, respectively. Third, because first sapphire wafer 12 has not yet been bonded to second sapphire wafer 18 and excess first filler 30 and second filler 50 can be polished away prior to the formation of capacitor chamber 24, first filler 30 and second filler 50 are not at risk of flowing into capacitor chamber 24 during formation of first via 14 and second via 20. Fourth, the hermeticity of first sapphire wafer 12 and first via 14 and the hermeticity of second sapphire wafer 18 and second via 20 is easier to test with first sapphire wafer 12 and second sapphire wafer 18 not bonded together, making it possible to ensure that first via 14 and second via 20 are hermetically sealed prior to forming capacitor chamber 24. Likewise, it is possible to easily test and ensure that first electrode 16 and second electrode 22 are sealed to and in electrical communication with first via 14 and second via 20, respectively, before first sapphire wafer 12 and second sapphire wafer 18 are bonded together. As such, the method for making capacitive pressure sensor 10 results in greater process robustness.

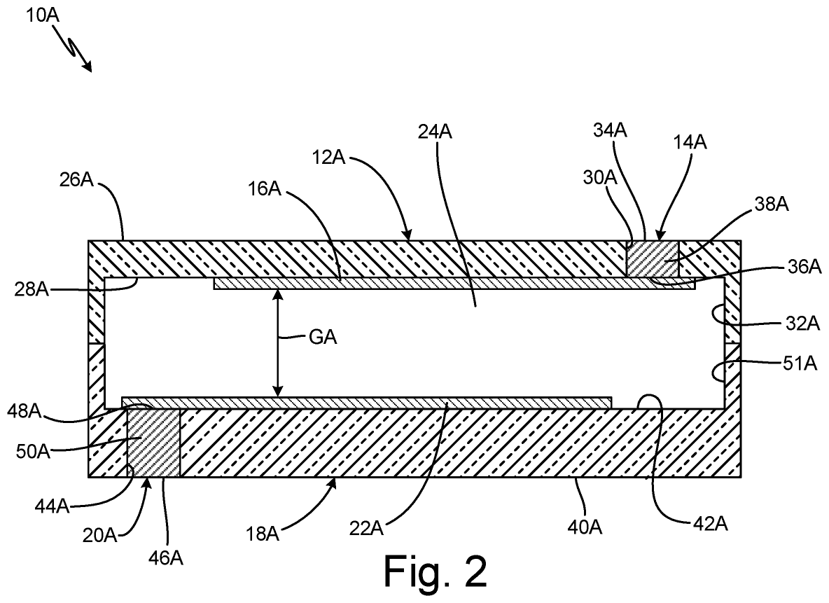

FIG. 2 is a cross-sectional view of capacitive pressure sensor 10A having first sapphire wafer 12A with first recess 32A and second sapphire wafer 18B with second recess 51A. Capacitive pressure sensor 10A includes first sapphire wafer 12A, first via 14A, first electrode 16A, second sapphire wafer 18A, second via 20A, second electrode 22A, and capacitor chamber 24A. First sapphire wafer 12A includes first exterior wafer surface 26A, first interior wafer surface 28A, first hole 30A, and first recess 32A. First via 14A includes first exterior via surface 34A, first interior via surface 36A, and first filler 38A. Second sapphire wafer 18A includes second exterior wafer surface 40A, second interior wafer surface 42A, second hole 44A, and second recess 51A. Second via 20A includes second exterior via surface 46A, second interior via surface 48A, and second filler 50A.

Capacitive pressure sensor 10A has the same structure and function as capacitive pressure sensor 10 in FIG. 1, except that second sapphire wafer 18A includes second recess 51A. First recess 32A has the same structure and function as described in reference to recess 32 of first sapphire wafer 12 of capacitive pressure sensor 10 in FIG. 1. Second recess 51A extends into second sapphire wafer 18A at second interior wafer surface 42A. Second recess 51A has a substantially uniform depth. Second electrode 22A is positioned on second interior wafer surface 42A within second recess 51A. Following the formation of first via 14A and second via 20A, second interior wafer surface 42A of second sapphire wafer 18A is etched to form second recess 51A. In alternate embodiments, second recess 32A may be etched before the formation of first via 14A and second via 20A. First sapphire wafer 12A is directly peripherally bonded to second sapphire wafer 18A at first interior wafer surface 28A and second interior wafer surface 42A, respectively, through sapphire-sapphire direct bonding under vacuum to hermetically seal first sapphire wafer 12A to second sapphire wafer 18A and to form capacitor chamber 24A. More specifically, first sapphire wafer 12A is bonded to second sapphire wafer 18A in a vacuum oven, and first recess 32A and second recess 51A define capacitor chamber 24A.

In this embodiment, capacitor chamber 24A formed by first recess 32A and second recess 51A has a larger gap GA than gap G described in reference to FIG. 1. In alternate embodiments, gap GA may be the same size or smaller than gap G. Having first sapphire wafer 12A with first recess 32A and second sapphire wafer 18A with second recess 51A offers a different packaging option for capacitive pressure sensor 10A.

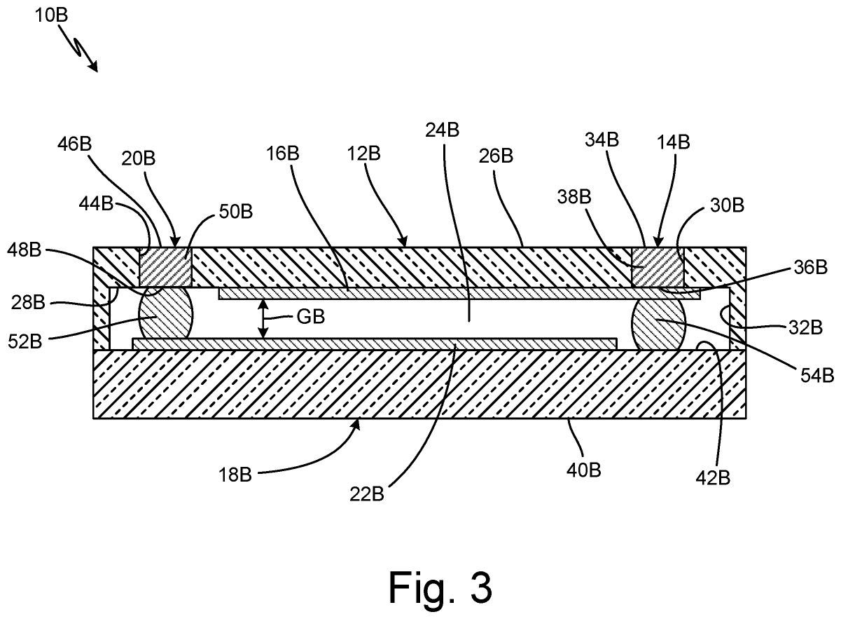

FIG. 3 is a cross-sectional view of capacitive pressure sensor 10B having first sapphire wafer 12B with first via 14B and second via 20B and connector 52B connecting second via 20B and second electrode 22B. Capacitive pressure sensor 10B includes first sapphire wafer 12B, first via 14B, first electrode 16B, second sapphire wafer 18B, second via 20B, second electrode 22B, capacitor chamber 24B, connector 52B, and spacer 54B. First sapphire wafer 12B includes first exterior wafer surface 26B, first interior wafer surface 28B, first hole 30B, recess 32B, and second hole 44B. First via 14B includes first exterior via surface 34B, first interior via surface 36B, and first filler 38B. Second sapphire wafer 18B includes second exterior wafer surface 40B and second interior wafer surface 42B. Second via 20B includes second exterior via surface 46B, second interior via surface 48B, and second filler 50B.

Capacitive pressure sensor 10B has a similar structure and function as capacitive pressure sensor 10 of FIG. 1 except that second via 20B extends through second hole 44B in first sapphire wafer 12B and connector 52B is bonded to second interior via surface 48B of second via 20B. Capacitive pressure sensor 10B is a high temperature capacitive pressure sensor. First sapphire wafer 12B is a dielectric single crystal sapphire membrane of capacitive pressure sensor 10B. In this embodiment, first sapphire wafer 12B is a movable wafer. First via 14B extends through first sapphire wafer 12B and is hermetically sealed to first sapphire wafer 12B. First via 14B is electrically conductive. First electrode 16B is positioned on first sapphire wafer 12B and first via 14B. First electrode 16B is also electrically connected to first via 14B. Second via 20B extends through first sapphire wafer 12B and is hermetically sealed to first sapphire wafer 12B. Second via 20B is electrically conductive. Second via 20B is spaced from first via 14B, and first electrode 16B does not contact second via 20B. Second sapphire wafer 18B is a dielectric single crystal sapphire membrane of capacitive pressure sensor 10B. In this embodiment, second sapphire wafer 18B is a stationary wafer. In alternate embodiments, second sapphire wafer 18B is a movable wafer. In further alternate embodiments, first sapphire wafer 12B is a stationary wafer and second sapphire wafer 18B is a movable wafer. Second electrode 22B is positioned on second sapphire wafer 18B.

Connector 52B is a conductive material connected to second electrode 22B and second via 20B. Second electrode 22B is electrically connected to second via 20B through connector 52B. Spacer 54B is connected to second sapphire wafer 18B and first electrode 16B such that spacer 54B is in alignment with first via 14B. Connector 52B and spacer 54B have the same shape and are symmetrically placed within capacitive pressure sensor 10B. First sapphire wafer 12B is peripherally and hermetically bonded to second sapphire wafer 18B to form capacitor chamber 24B, first electrode 16B and second electrode 22B being within capacitor chamber 24B. Capacitor chamber 24B is hermetically sealed. First electrode 16B is opposite second electrode 22B within capacitor chamber 24B, such that gap GB is formed between first electrode 16B and second electrode 22B.

First exterior wafer surface 26B is at a first side of first sapphire wafer 12B, and first interior wafer surface 28B is at a second side of first sapphire wafer 12B. First interior wafer surface 28B partially defines capacitor chamber 24B. First hole 30B is an opening defined by first sapphire wafer 12B that extends through first sapphire wafer 12B from first exterior wafer surface 26B to first interior wafer surface 28B. Second hole 44B is an opening defined by first sapphire wafer 12B that extends through first sapphire wafer 12B from first exterior wafer surface 26B to first interior wafer surface 28B. Second hole 44B is spaced from first hole 30B. Recess 32B extends into first sapphire wafer 12B at first interior wafer surface 28B. Recess 32B has a substantially uniform depth. First electrode 16B is positioned on first interior wafer surface 28B within recess 32B.

First exterior via surface 34B is at a first side of first via 14B, and first interior via surface 36B is at a second side of first via 14B. First via 14B is within first hole 30B such that first via 14B solidly fills first hole 30B, or takes up the entire space of first hole 30B such that first hole 30B is completely filled and no air gaps exist between first via 14B and first hole 30B. First exterior via surface 34B is about flush, or essentially co-planar, with first exterior wafer surface 26B, and first interior via surface 36B is about flush, or essentially co-planar, with first interior wafer surface 28B. First electrode 16B is positioned on first interior wafer surface 28B and first interior via surface 36B. First interior via surface 36B may be slightly dimpled, but remains aligned with first interior wafer surface 28B so that first electrode 16B contacts and covers first interior via surface 36B. In this embodiment, first electrode 16B fully covers first interior via surface 36B. First via 14B comprises, or is formed of, electrically conductive first filler 38B. In this embodiment, first filler 38B is a gold-based paste or material that becomes solid gold during formation of first via 14B. As such, first filler 38B begins as a paste primarily made of gold and solidifies to become solid gold, which has a high melting point. In alternate embodiments, first filler 38B may be a platinum-based material or any other suitable metal-based material that solidifies to become a solid metal with a high melting point such that first filler 38B can withstand extreme high temperature applications.

Second exterior via surface 46B is at a first side of second via 20B, and second interior via surface 48B is at a second side of second via 20B. Second via 20B is within second hole 44B such that second via 20B solidly fills second hole 44B, or takes up the entire space of second hole 44B such that second hole 44B is completely filled and no air gaps exist between second via 20B and second hole 44B. Second exterior via surface 46B is about flush, or essentially co-planar, with first exterior wafer surface 26B, and second interior via surface 48B is about flush, or essentially co-planar, with first interior wafer surface 28B. Second interior via surface 48B may be slightly dimpled, but remains aligned with first interior wafer surface 28B. Second via 20B comprises, or is formed of, electrically conductive second filler 50B. In this embodiment, second filler 50B is a gold-based paste or material that becomes solid gold during formation of second via 20B. As such, second filler 50B begins as a paste primarily made of gold and solidifies to become solid gold, which has a high melting point. In alternate embodiments, second filler 50B may be a platinum-based material or any other suitable metal-based material that solidifies to become a solid metal with a high melting point such that second filler 50B can withstand extreme high temperature applications. Connector 52B is connected to second interior via surface 48B and second electrode 22B, extending between second interior via surface 48B and second electrode 22B. As such, connector 52B is in alignment with second via 20B. Connector 52B is electrically conductive. In this embodiment, connector 52B is made of a gold-based material including a filler that lowers the melting point of connector 52B below the melting point of first filler 38B and the melting point of second filler 50B, the melting point of first filler 38B and the melting point of second filler 50B being the same. In alternate embodiments, connector 52B may be made of any suitable material capable of withstanding extreme high temperature applications.

Second exterior wafer surface 40B is at a first side of second sapphire wafer 18B, and second interior wafer surface 42B is at a second side of second sapphire wafer 18B. Second interior wafer surface 42B partially defines capacitor chamber 24B. Second electrode 22B is positioned on second interior wafer surface 42B. Spacer 54B is connected to second interior wafer surface 42B of second sapphire wafer 18B and first electrode 16B. Spacer 54B is made of the same material as connector 52B.

Capacitive pressure sensor 10B is made by drilling, such as by laser drilling, first hole 30B and second hole 44B in first sapphire wafer 12B. First hole 30B is solidly, or completely, filled with first via 14B, and second hole 44B is solidly, or completely, filled with second via 20B. To fill first hole 30B and second hole 44B, first filler 38B of first via 14B is pressed into first hole 30B in the form of a paste, and second filler 50B of second via 20B is pressed into second hole 44B in the form of a paste. First filler 38B and second filler 50B are then heated until first filler 38B and second filler 50B bond and solidify to become hermetically sealed to first sapphire wafer 12B. Because first via 14B and second via 20B comprise first filler 38B and second filler 50B, respectively, which have high melting points, such a bonding process occurs at a temperature high enough to melt.

The first sapphire wafer 12B is then EPI-polished to grind down, or remove, excess first filler 30B and second filler 50B, respectively, until first exterior via surface 34B, first interior via surface 36B, second exterior via surface 46B, and second interior via surface 48B are essentially flat and first sapphire wafer 12B is restored for further bonding. Specifically, first sapphire wafer 12B, first via 14B, and second via 20B are polished such that first exterior via surface 34B and second exterior via surface 46B are about flush, or essentially co-planar, with first exterior wafer surface 26B and first interior via surface 36B and second interior via surface 48B are about flush, or essentially co-planar, with first interior wafer surface 28B. Second sapphire wafer 18B may also be EPI-polished for further bonding. Following the formation of first via 14B and second via 20B, first interior wafer surface 28B of first sapphire wafer 12B is then etched to form recess 32B. In alternate embodiments, recess 32B may be etched before the formation of first via 14B and second via 20B.

First electrode 16B is deposited on an essentially flat surface formed by first interior wafer surface 28B and first interior via surface 36B such that first electrode 16B is positioned on both first interior wafer surface 28B and first interior via surface 36B. First electrode 16B does not contact second interior via surface 48B. Second electrode 22B is deposited on second interior wafer surface 42B.

Connector 52B is bonded to second interior via surface 48B of second via 20B after first electrode 16B and second electrode 22B are deposited on first sapphire wafer 12B and second sapphire wafer 18B, respectively, but before first sapphire wafer 12B is bonded to second sapphire wafer 18B. Spacer 54B is bonded to second interior wafer surface 42B. Connector 52B and spacer 54B may be spherical or any other suitable shape prior to bonding. First sapphire wafer 12B is directly peripherally bonded to second sapphire wafer 18B at first interior wafer surface 28B and second interior wafer surface 42B, respectively, through sapphire-sapphire direct bonding under vacuum to hermetically seal first sapphire wafer 12B to second sapphire wafer 18B and to form capacitor chamber 24B. More specifically, first sapphire wafer 12B is bonded to second sapphire wafer 18B in a vacuum oven, and first recess 32B partially defines capacitor chamber 24B. As a result, capacitor chamber 24B is a vacuum chamber, which is required for pressure sensing.

When first sapphire wafer 12B is bonded to second sapphire wafer 18B, the increase in temperature softens connector 52B and spacer 54B such that second electrode 22B presses down on connector 52B and bonds to connector 52B and first electrode 16B presses down on spacer 54B and bonds to spacer 54B. Second via 20B is electrically connected to second electrode 22B through connector 52B.

Alternatively, connector 52B is bonded to second electrode 22B in alignment with second via 20B, and spacer 54B is bonded to first electrode 16B in alignment with first via 14B. When first sapphire wafer 12B is bonded to second sapphire wafer 18B, the increase in temperature softens connector 52B and spacer 54B such that second interior via surface 48B of second via 20B presses down on connector 52B and bonds to connector 52B and second interior wafer surface 42B presses down on spacer 54B and becomes connected to spacer 54B. Second via 20B is electrically connected to second electrode 22B through connector 52B.

First sapphire wafer 12B and second sapphire wafer 18B withstand extreme high temperatures because they are made of sapphire. Additionally, first filler 38B and second filler 50B that make up first via 14B and second via 20B, respectively, can withstand extreme high temperatures because they are made of materials with high melting points. As such, capacitive pressure sensor 10B has the ability to measure pressure in extreme high temperature environments.

Capacitive pressure sensor 10B measures pressure by detecting a capacitance change between first electrode 16B and second electrode 18B. Capacitance is a function of gap GB between first electrode 16B and second electrode 18B. Gap GB changes when movable first sapphire wafer 12B deflects toward or away from stationary second sapphire wafer 18B as a result of external pressure due to the vacuum within capacitor chamber 24B. First via 14B and second via 20B are physically and electrically connected to first electrode 16B and second electrode 22B, respectively, to communicate the capacitance change as first sapphire wafer 12B and second sapphire wafer 18B are non-conductive. Connector 52B electrically connects second electrode 22B to second via 20B. Spacer 54B creates symmetry within capacitive pressure sensor 10B.

First via 14B and second via 20B solidly fill first hole 30B and second hole 44B, respectively, to achieve hermetic sealing. Polishing down excess first filler 30B creates a flat surface that allows first electrode 16B to fully cover first interior via surface 36B, so that no leaks can occur at edges of first via 14B. Specifically, first electrode 16B can fully cover first interior via surface 36B because first interior via surface 36B is about flush with first interior wafer surface 28B. As a result, first electrode 16B provides another layer of sealing by covering first hole 30B, further ensuring that capacitor chamber 24B is hermetically sealed.

Capacitive pressure sensor 10B is suitable for use in extreme high temperature applications, such as 800 degrees Celsius or above, and other harsh environmental applications. Because first via 14B and second via 20B are made of gold-based material that has a melting point higher than traditional fillers, first via 14B and second via 20B are not at risk of outgassing or reflowing and still provide good electric conduction. Capacitive pressure sensor 10B is easy to hermetically seal because first hole 30B and second hole 44B are solidly filled with first via 14B and second via 20B. Capacitive pressure sensor 10B remains hermetically sealed not only because first via 14B and second via 18B do not outgas or reflow, but also because first electrode 16B provides an additional seal over first hole 30B. Maintaining hermeticity is important because capacitive pressure sensor 10B must be hermetically sealed in order to maintain a vacuum within capacitor chamber 24B, which is necessary in order for capacitive chamber 24B to function properly.

More control over the formation of capacitive pressure sensor 10B is also possible because first via 14B and second via 20B are formed before first sapphire wafer 12B is bonded to second sapphire wafer 18B. First, since first via 14B and second via 20B are formed before capacitor chamber 24B is formed, high temperature first filler 30B and second filler 50B can be used without considering high temperature heating effects on other processes or components of capacitive pressure sensor 10B. Second, because first sapphire wafer 12B is still separate from second sapphire wafer 18B, first interior wafer surface 28B, first interior via surface 36B, and second interior via surface 48B are easily visible and accessible. As a result, first interior via surface 36B and second interior via surface 48B can be polished, and first electrode 16B can be deposited on first interior via surface 36B. Third, because first sapphire wafer 12B has not yet been bonded to second sapphire wafer 18B and excess first filler 30B and second filler 50B can be polished away prior to the formation of capacitor chamber 24B, first filler 30B and second filler 50B are not at risk of flowing into capacitor chamber 24B during formation of first via 14B and second via 20B. Fourth, the hermeticity of first sapphire wafer 12B, first via 14B, and second via 20B is easier to test with first sapphire wafer 12B and second sapphire wafer 18B not bonded together, making it possible to ensure that first via 14B and second via 20B are hermetically sealed prior to forming capacitor chamber 24B. Likewise, it is possible to easily test and ensure that first electrode 16B is sealed to and in electrical communication with first via 14B before first sapphire wafer 12B and second sapphire wafer 18B are bonded together. As such, the method for making capacitive pressure sensor 10B results in greater process robustness.

Forming first via 14B and second via 20B in first sapphire wafer 12B is cost-effective as only one wafer requires drilling. Additionally, placing both first via 14B and second via 20B in first sapphire wafer 12B offers a different packaging option for capacitive pressure sensor 10B.

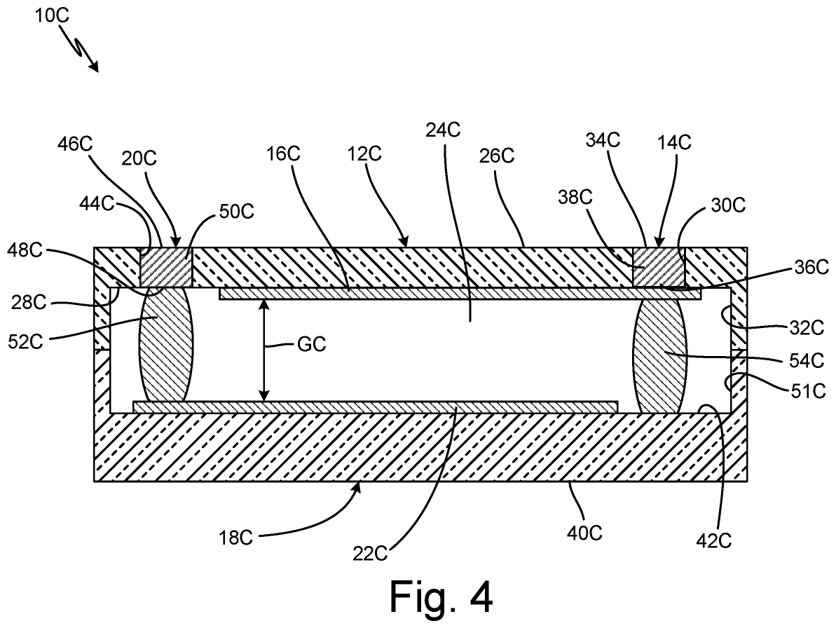

FIG. 4 is a cross-sectional view of capacitive pressure sensor 10C having first sapphire wafer 12C with first via 14C, second via 20C, first recess 32C, and connector 52C connecting second via 20C and second electrode 22C of second sapphire wafer 18C having second recess 51C. Capacitive pressure sensor 10C includes first sapphire wafer 12C, first via 14C, first electrode 16C, second sapphire wafer 18C, second via 20C, second electrode 22C, capacitor chamber 24C, connector 52C, and spacer 54C. First sapphire wafer 12C includes first exterior wafer surface 26C, first interior wafer surface 28C, first hole 30C, first recess 32C, and second hole 44C. First via 14C includes first exterior via surface 34C, first interior via surface 36C, and first filler 38C. Second sapphire wafer 18C includes second exterior wafer surface 40C, second interior wafer surface 42C, and second recess 51C. Second via 20C includes second exterior via surface 46C, second interior via surface 48C, and second filler 50C.

Capacitive pressure sensor 10C has the same structure and function as capacitive pressure sensor 10B in FIG. 3, except that second sapphire wafer 18C includes second recess 51C. First recess 32C has the same structure and function as described in reference to recess 32B of first sapphire wafer 12B of capacitive pressure sensor 10B in FIG. 3. Second recess 51C extends into second sapphire wafer 18C at second interior wafer surface 42C. Second recess 51C has a substantially uniform depth. Second electrode 22C is positioned on second interior wafer surface 42C within second recess 51C. Following the formation of first via 14C and second via 20C, second interior wafer surface 42C of second sapphire wafer 18C is etched to form second recess 51C. In alternate embodiments, second recess 32C may be etched before the formation of first via 14C and second via 20C. First sapphire wafer 12C is directly peripherally bonded to second sapphire wafer 18C at first interior wafer surface 28C and second interior wafer surface 42C, respectively, through sapphire-sapphire direct bonding under vacuum to hermetically seal first sapphire wafer 12C to second sapphire wafer 18C and to form capacitor chamber 24C. More specifically, first sapphire wafer 12C is bonded to second sapphire wafer 18C in a vacuum oven, and first recess 32C and second recess 51C define capacitor chamber 24C.

In this embodiment, capacitor chamber 24C formed by first recess 32C and second recess 51C has a larger gap GC than gap GB described in reference to FIG. 3. In alternate embodiments, gap GC may be the same size or smaller than gap GB. Having first sapphire wafer 12C with first recess 32C and second sapphire wafer 18C with second recess 51C offers a different packaging option for capacitive pressure sensor 10C.

### Discussion of Possible Embodiments

The following are non-exclusive descriptions of possible embodiments of the present invention.

A high temperature capacitive pressure sensor includes a first sapphire wafer having a first exterior wafer surface and a first interior wafer surface; a first recess extending into the first sapphire wafer at the first interior wafer surface; a second sapphire wafer having a second exterior wafer surface and a second interior wafer surface, wherein the second sapphire wafer is bonded to the first sapphire wafer at the first interior wafer surface and the second interior wafer surface to form a capacitor chamber; a first hole defined by and extending through the first sapphire wafer; a second hole defined by and extending through the first sapphire wafer or the second sapphire wafer; a first electrically conductive via that solidly fills the first hole, the first via including a first interior via surface aligned with the first interior wafer surface; a second electrically conductive via that solidly fills the second hole, the second via including a second interior via surface aligned with the interior wafer surface of the sapphire wafer within which the second via extends; a first electrode deposited on the first interior wafer surface within the first recess and covering and contacting the first interior via surface; and a second electrode deposited on the second interior wafer surface and electrically connected to the second via.

The capacitive pressure sensor of the preceding paragraph can optionally include, additionally and/or alternatively, any one or more of the following features, configurations and/or additional components:

The second hole extends through the second sapphire wafer, the second via is hermetically sealed to the second sapphire wafer, and the second electrode covers the second interior via surface.

The second electrode fully covers the second interior via surface.

The second hole extends through the first sapphire wafer, and the second electrode is electrically connected to the second via through an electrically conductive connector that extends between the second electrode and the second interior via surface.

The connector has a melting point lower than a melting point of the first via and a melting point of the second via, the melting point of the first via being the same as the melting point of the second via.

A second recess extending into the second sapphire wafer at the second interior wafer surface, wherein the second electrode is deposited on the second interior wafer surface within the second recess, and the first recess and the second recess define the capacitor chamber.

The first via is hermetically sealed to the first sapphire wafer, and the second sapphire wafer is hermetically bonded to the first sapphire wafer.

The capacitor chamber is a vacuum chamber, the first via comprises a first filler, and the second via comprises a second filler, the first filler and the second filler being made of a gold-based material that becomes solid gold upon heating or a platinum-based material that becomes solid platinum upon heating.

The first electrode fully covers the first interior via surface of the first via.

A method of making a capacitive pressure sensor includes drilling a first hole in a first sapphire wafer; solidly filling the first hole with an electrically conductive first filler of a first via; polishing the first sapphire wafer and the first via such that a first interior via surface is aligned with a first interior wafer surface; depositing a first electrode on the first interior via surface and the first interior wafer surface; and bonding the first sapphire wafer to a second sapphire wafer to form a capacitor chamber, the first electrode being within the capacitor chamber.

The method of the preceding paragraph can optionally include, additionally and/or alternatively, any one or more of the following features, configurations and/or additional components:

Polishing the first sapphire wafer and the first via such that the first interior via surface is flush with a first interior wafer surface.

Etching the first interior wafer surface to form a first recess, wherein the first electrode is deposited within the first recess.

The capacitor chamber is formed to be a vacuum chamber.

Drilling a second hole in the second sapphire wafer; solidly filling the second hole with an electrically conductive second filler of a second via; polishing the second sapphire wafer and the second via such that a second interior via surface is aligned with a second interior wafer surface; and depositing a second electrode on the second interior via surface and the second interior wafer surface before bonding the first sapphire wafer to the second sapphire wafer, the second electrode being within the capacitor chamber.

Etching the second interior wafer surface to form a second recess, wherein the second electrode is deposited within the second recess.

Drilling a second hole in the first sapphire wafer; solidly filling the second hole with an electrically conductive second filler of a second via; polishing the second via such that a second interior via surface is aligned with a first interior wafer surface; and depositing a second electrode on a second interior wafer surface of the second sapphire wafer before bonding the first sapphire wafer to the second sapphire wafer, the second electrode being within the capacitor chamber.

Bonding a connector to a second interior via surface of the second via.

Bonding the first sapphire wafer to the second sapphire wafer includes bonding the connector to the second electrode on the second sapphire wafer.

Bonding a connector to the second electrode on the second sapphire wafer, wherein the connector is in alignment with the second via.

Bonding the first sapphire wafer to the second sapphire wafer includes bonding the connector to a second interior via surface of the second via.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A high temperature capacitive pressure sensor comprising:
a first sapphire wafer having a first exterior wafer surface and a first interior wafer surface;
a first recess extending into the first sapphire wafer at the first interior wafer surface;
a second sapphire wafer having a second exterior wafer surface and a second interior wafer surface, wherein the second sapphire wafer is bonded to the first sapphire wafer at the first interior wafer surface and the second interior wafer surface to form a capacitor chamber;
a first hole defined by and extending through the first sapphire wafer;
a second hole defined by and extending through the first sapphire wafer or the second sapphire wafer;
a first electrically conductive via that solidly fills the first hole, the first via including a first interior via surface aligned with the first interior wafer surface;
a second electrically conductive via that solidly fills the second hole, the second via including a second interior via surface aligned with the interior wafer surface of the sapphire wafer within which the second via extends;
a first electrode deposited on the first interior wafer surface within the first recess and covering and contacting the first interior via surface; and
a second electrode deposited on the second interior wafer surface and electrically connected to the second via.

2. The capacitive pressure sensor of claim 1, wherein the second hole extends through the second sapphire wafer, the second via is hermetically sealed to the second sapphire wafer, and the second electrode covers and contacts the second interior via surface.

3. The capacitive pressure sensor of claim 2, wherein the second electrode fully covers the second interior via surface.

4. The capacitive pressure sensor of claim 1, wherein the second hole extends through the first sapphire wafer, and the second electrode is electrically connected to the second via through an electrically conductive connector that extends between the second electrode and the second interior via surface.

5. The capacitive pressure sensor of claim 4, wherein the connector has a melting point lower than a melting point of the first via and a melting point of the second via, the melting point of the first via being the same as the melting point of the second via.

6. The capacitive pressure sensor of claim 1, further including a second recess extending into the second sapphire wafer at the second interior wafer surface, wherein the second electrode is deposited on the second interior wafer surface within the second recess, and the first recess and the second recess define the capacitor chamber.

7. The capacitive pressure sensor of claim 1, wherein the first via is hermetically sealed to the first sapphire wafer, and the second sapphire wafer is hermetically bonded to the first sapphire wafer.

8. The capacitive pressure sensor of claim 1, wherein the capacitor chamber is a vacuum chamber, the first via comprises a first filler, and the second via comprises a second filler, the first filler and the second filler being made of a gold-based material that becomes solid gold upon heating or a platinum-based material that becomes solid platinum upon heating.

9. The capacitive pressure sensor of claim 1, wherein the first electrode fully covers the first interior via surface of the first via.

10. A method of making a capacitive pressure sensor, the method comprising:
drilling a first hole in a first sapphire wafer;
solidly filling the first hole with an electrically conductive first filler of a first via;
polishing the first sapphire wafer and the first via such that a first interior via surface is aligned with a first interior wafer surface;
depositing a first electrode on the first interior via surface and the first interior wafer surface; and
bonding the first sapphire wafer to a second sapphire wafer to form a capacitor chamber, the first electrode being within the capacitor chamber.

11. The method of claim 10, further including polishing the first sapphire wafer and the first via such that the first interior via surface is flush with a first interior wafer surface.

12. The method of claim 10, further including etching the first interior wafer surface to form a first recess, wherein the first electrode is deposited within the first recess.

13. The method of claim 10, wherein the capacitor chamber is formed to be a vacuum chamber.

14. The method of claim 10, and further including drilling a second hole in the second sapphire wafer;
solidly filling the second hole with an electrically conductive second filler of a second via;
polishing the second sapphire wafer and the second via such that a second interior via surface is aligned with a second interior wafer surface; and
depositing a second electrode on the second interior via surface and the second interior wafer surface before bonding the first sapphire wafer to the second sapphire wafer, the second electrode being within the capacitor chamber.

15. The method of claim 14, further including etching the second interior wafer surface to form a second recess, wherein the second electrode is deposited within the second recess.

16. The method of claim 10, and further including drilling a second hole in the first sapphire wafer;
solidly filling the second hole with an electrically conductive second filler of a second via;
polishing the second via such that a second interior via surface is aligned with a first interior wafer surface; and
depositing a second electrode on a second interior wafer surface of the second sapphire wafer before bonding the first sapphire wafer to the second sapphire wafer, the second electrode being within the capacitor chamber.

17. The method of claim 16, and further including bonding a connector to a second interior via surface of the second via.

18. The method of claim 17, wherein bonding the first sapphire wafer to the second sapphire wafer includes bonding the connector to the second electrode on the second sapphire wafer.

19. The method of claim 16, and further including bonding a connector to the second electrode on the second sapphire wafer, wherein the connector is in alignment with the second via.

20. The method of claim 19, wherein bonding the first sapphire wafer to the second sapphire wafer includes bonding the connector to a second interior via surface of the second via.
